(19) United States
(12) Patent Application Publication
(10) Pub. No.: US 2008/0070999 A1
(43) Pub. Date: Mar. 20, 2008

(54) Alkylpolyglycosides useful as stabilizers for pur foams

(75) Inventors: Michael Mager, Leverkusen (DE); Jan Schonberger, Solingen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/900,594

(22) Filed: Sep. 12, 2007

(30) Foreign Application Priority Data
Sep. 16, 2006 (DE) 102006043589.3

(51) Int. Cl. C08J 9/28; C07G 3/00; C08L 75/00

(52) U.S. Cl. 521/64; 521/137

(57) ABSTRACT

The invention relates to polyurethane foam forming compositions which produce hydrophilicized polyurethane foams, in particular foams which are suitable as wound dressing foams. These compositions comprise (I) a polyurethane dispersion and (II) specific additives including one or more alkylpolyglycoside. The process of producing these foams comprises frothing and drying these polyurethane foam forming compositions.

### CROSS-REFERENCE TO RELATED PATENT APPLICATION

The present patent application claims the right of priority under 35 U.S.C. §119 (a)-(d) of German Patent Application No. 10 2006 043 589.3 filed on Sep. 16, 2006.

### BACKGROUND OF THE INVENTION

The invention relates to compositions for producing hydrophilicized polyurethane foams, in particular wound dressing foams, wherein the polyurethane foam composition comprises a polyurethane dispersion and specific additives that are frothed and dried to form the foam. This invention also relates to a process for producing these hydrophilicized polyurethane foams. This process comprises frothing and drying of a polyurethane foam forming composition in which the polyurethane foam forming composition comprises a polyurethane dispersion and specific additives.

In the field of wound management, polyurethane wound dressing foams are known to be suitable for treating weeping wounds. Due to their high absorbency and their good mechanical properties, polyurethane foams produced by reaction of mixtures of diisocyanates and polyols or NCO-functional polyurethane prepolymers with water in the presence of certain catalysts and also (foam) additives are generally used. Aromatic diisocyanates are generally employed, since they exhibit the best foaming properties. Numerous forms of these processes for producing polyurethane foams are known and described in, for example, U.S. Pat. No. 3,978,266, U.S. Pat. No. 3,975,567 and EP-A 0 059 048. The aforementioned processes, however, have the disadvantage that they require the use of reactive mixtures, containing diisocyanates or corresponding NCO-functional prepolymers, the handling of which is technically inconvenient and costly, due to the necessary appropriate protective measures associated with such diisocyanates or NCO-functional prepolymers of these diisocyanates.

One alternative to the above-described process which utilizes diisocyanates or NCO-functional polyurethane prepolymers, is a process based on polyurethane dispersions (which are essentially free of isocyanate groups) into which air is incorporated by vigorous stirring in the presence of suitable (foam) additives. The so-called mechanical polyurethane foams are obtained after drying and curing. In connection with polyurethane wound dressing foams, such are described in EP-A 0 235 949 and EP-A 0 246 723, with the foam either having a self-adherent polymer added to it, or the foam being applied to a film of a self-adherent polymer. U.S. Pat. No. 4,655,210 describes the use of the aforementioned mechanical foams for wound dressings having a specific construction made up of backing, a foam and a skin contact layer. As described in EP-A 0 235 949, EP-A 0 246 723 and U.S. Pat. No. 4,655,210, such foams were always produced from the polyurethane dispersions using additive mixtures containing essentially ammonium stearate. This is an immense disadvantage, since ammonium stearate leads to a distinct hydrophobicization of the foams and thus, appreciably reduces the rate of uptake of liquid. This is unacceptable, particularly for wound contact foams. In addition, ammonium stearate is thermally decomposable, and the ammonia formed has to be removed, which is technically inconvenient. On the other hand, ammonium stearate cannot simply be replaced by other stearates or completely different (foam) additives, since they fail to give a comparatively good foam structure, which is particularly characterized by very fine pores.

An object of the present invention is to provide suitable (foam) additives which can be frothed in combination with aqueous polyurethane dispersions and which, after drying, provide foams having very fine pores and which are homogeneous even when very thick. In addition, these foams should possess improved hydrophilicity and, associated therewith, a good water uptake and water vapor permeability, in comparison to foams stabilized with ammonium stearates. The desired foams should also be very substantially free of (thermally) detachable components such as amines.

It has now been found that the above described object is achieved by using alkylpolyglycosides as a (foam) additive.

### SUMMARY OF THE INVENTION

The present invention accordingly provides for polyurethane foam forming compositions which comprise (I) at least one aqueous, anionically hydrophilized polyurethane dispersion, and (II) one or more foam additives in which the additives comprise one or more alkylpolyglycosides. The alkylpolyglycosides act as stabilizers for the polyurethane foams. Preferably, these alkylpolyglycosides also provide additional hydrophilicization, as well as stabilization, of the foams. Preferably, the aforementioned polyurethane foams produced by a process in which the foam forming compositions are frothed, followed by physical drying.

The present invention further provides a process for producing polyurethane wound dressing foams which comprises frothing and drying a polyurethane foam forming composition, in which the polyurethane foam forming composition comprises (I) at least one aqueous, anionically hydrophilicized polyurethane dispersion, and (II) one or more additives, wherein (II) said foam additives comprise at least an alkylpolyglycoside.

Suitable aqueous, anionically hydrophilicized polyurethane dispersions to be used as component (I) in the polyurethane foam forming compositions essential to the present invention comprise the reaction product of:

A) one or more isocyanate-functional prepolymers which comprise the reaction product of:

A1) at least one organic polyisocyanate, with

A2) at least one polymeric polyol having a number-average molecular weight in the range from 400 to 8000 g/mol and an OH functionality in the range from 1.5 to 6, and

A3) optionally, one or more hydroxyl-functional compounds having molecular weights in the range from 62 to 399 g/mol, and

A4) optionally, one or more isocyanate-reactive, anionic or potentially anionic and/or optionally nonionic hydrophilicizing agents; with

B) one or more compounds selected from the group consisting of:

B1) optionally, one or more amino-functional compounds having molecular weights in the range from 32 to 400 g/mol, and

B2) one or more isocyanate-reactive, preferably amino-functional, anionic or potentially anionic hydrophilicizing agents;

in which the NCO groups of A) said prepolymers are wholly or partially reacted with isocyanate-reactive groups of B) by chain extension, and in which the prepolymers are dispersed in water before, during or after the reaction with component B), and with any potentially ionic groups present being converted into the ionic form by partial or complete reaction with a neutralizing agent.

Significantly, the compounds of components A1) to A4) have no primary or secondary amino groups.

To achieve anionic hydrophilicization, components A4) and/or B2) contain hydrophilicizing agents that have at least one NCO-reactive group such as amino, hydroxyl and/or thiol groups, and additionally have —COO⁻ or —SO₃⁻ or PO₃²⁻ as anionic groups or their wholly or partly protonated acid forms as potential anionic groups.

### DETAILED DESCRIPTION OF THE INVENTION

The preferred aqueous, anionic polyurethane dispersions used as component (I) have a low degree of hydrophilic anionic groups. More specifically, these preferably have from 0.1 to 15 milliequivalents of hydrophilic anionic groups per 100 g of solid resin (i.e. solid polyurethane).

To achieve good sedimentation stability, the number average particle size of the specific polyurethane dispersions is preferably less than 750 nm and more preferably less than 550 nm. As used herein, the number average particle sized is determined by laser correlation spectroscopy.

In the production of A) the isocyanate-functional prepolymer from components A1) to A4), the molar ratio of isocyanate (i.e. NCO) groups of compounds of component A1) to isocyanate-reactive (i.e. NCO-reactive) groups such as amino, hydroxyl or thiol groups of compounds of components A2) to A4) is in the range from 1.05:1 to 3.5:1, preferably in the range from 1.2:1 to 3.0:1 and more preferably in the range from 1.3:1 to 2.5:1. These ratios are preferred for the preparation of the NCO-functional prepolymer, i.e. component A).

The amino-functional compounds which are suitable for use as components B1) and B2) are present in such an amount that the equivalent ratio of isocyanate-reactive amino groups of these compounds of components B1) and B2) to the free isocyanate groups of the prepolymer, i.e. component A), is in the range from 40 to 150%, preferably between 50 to 125%, and more preferably between 60 to 120%.

Suitable organic polyisocyanates to be used as component A1) include the well-known aromatic, araliphatic, aliphatic or cycloaliphatic polyisocyanates of an NCO functionality of≧2.

Examples of such suitable polyisocyanates are 1,4-butylene diisocyanate, 1,6-hexamethylene diisocyanate (HDI), isophorone diisocyanate (IPDI), 2,2,4 and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-toluene diisocyanate, 1,5-naphthalene diisocyanate, 2,2′- and/or 2,4′- and/or 4,4′-diphenyl-methane diisocyanate, 1,3- and/or 1,4-bis(2-isocyanatoprop-2-yl)benzene (TMXDI), 1,3-bis(isocyanatomethyl)benzene (XDI), and also alkyl 2,6-diisocyanatohexanoate (lysine diisocyanates) having C₁-C₈-alkyl groups, and 4-isocyanatomethyl-1,8-octane diisocyanate (nonane triisocyanate) and triphenylmethane 4,4′,4″-triisocyanate.

In addition to the aforementioned polyisocyanates, it is also possible to use, proportionally, modified diisocyanates or triisocyanates of uretdione, isocyanurate, urethane, allophanate, biuret, iminooxadiazinedione and/or oxadiazinetrione structure.

Preferably, the polyisocyanates or polyisocyanate mixtures of the aforementioned kind have exclusively aliphatically and/or cycloaliphatically attached isocyanate groups and an average NCO functionality in the range from 2 to 4, preferably in the range from 2 to 2.6, and more preferably in the range from 2 to 2.4 for the mixture.

It is particularly preferable for component A1) to comprise 1,6-hexamethylene diisocyanate, isophorone diisocyanate, the isomeric bis(4,4′-isocyanatocyclo-hexyl)methanes, and/or mixtures thereof.

Component A2) comprisesone or more polymeric polyols having a number average molecular weight Mₙ in the range from 400 to 8000 g/mol, preferably from 400 to 6000 g/mol, and more preferably from 600 to 3000 g/mol. These also have an OH functionality in the range from 1.5 to 6, preferably in the range from 1.8 to 3, more preferably in the range from 1.9 to 2.1.

Such polymeric polyols are the well-known polyurethane coating technology polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and polyester polycarbonate polyols. These can be used either individually or in any desired mixtures with one another as component A2).

These polyester polyols are the well-known polycondensates formed from di- and also optionally tri- and tetraols, with di- and also optionally tri- and tetracarboxylic acids or hydroxy carboxylic acids or lactones. Instead of the free polycarboxylic acids it is also possible to use the corresponding polycarboxylic anhydrides or corresponding polycarboxylic esters of lower alcohols for preparing the polyesters.

Examples of suitable diols are ethylene glycol, butylene glycol, diethylene glycol, triethylene glycol, polyalkylene glycols such as polyethylene glycol, also 1,2-propane-diol, 1,3-propanediol, butanediol(1,3), butanediol(1,4), hexanediol(1,6) and isomers thereof, neopentyl glycol or neopentyl glycol hydroxypivalate. Of these, hexanediol(1,6) and isomers thereof, neopentyl glycol and neopentyl glycol hydroxypivalate are preferred. Besides these, it is also possible to use polyols such as trimethylolpropane, glycerol, erythritol, pentaerythritol, trimethylolbenzene or trishydroxyethyl isocyanurate.

Suitable dicarboxylic acids include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethyl glutaric acid and/or 2,2-dimethylsuccinic acid. The corresponding anhydrides can also be used as a source of an acid.

When the average functionality of the polyol to be esterified is>than 2, monocarboxylic acids, such as benzoic acid and hexanecarboxylic acid can be used as well in addition.

Preferred dicarboxylic acids are aliphatic or aromatic acids of the aforementioned kind. Adipic acid, isophthalic acid and optionally, trimellitic acid are particularly preferred.

Hydroxy carboxylic acids useful as reaction participants in the preparation of a polyester polyol having terminal hydroxyl groups include for example hydroxycaproic acid, hydroxybutyric acid, hydroxydecanoic acid, hydroxystearic acid and the like. Suitable lactones include caprolactone, butyrolactone and homologues. Caprolactone is preferred.

Likewise, component A2) may comprise one or more hydroxyl-containing polycarbonates, preferably one or more polycarbonate diols, having number average molecular weights Mₙ in the range from 400 to 8000 g/mol and preferably in the range from 600 to 3000 g/mol. These are obtainable by reaction of carbonic acid derivatives, such as diphenyl carbonate, dimethyl carbonate or phosgene, with polyols, preferably diols.

Examples of such diols are ethylene glycol, 1,2-propanediol, 1,3-propanediol, 1,3-butanediol, 1,4-butanediol, 1,6-hexanediol, 1,8-octanediol, neopentyl glycol, 1,4-bishydroxymethylcyclohexane, 2-methyl-1,3-propanediol, 2,2,4-trimethyl-1,3-pentanediol, dipropylene glycol, polypropylene glycols, dibutylene glycol, poly-butylene glycols, bisphenol A and lactone-modified diols of the aforementioned kind.

The polycarbonate diol preferably contains 40% to 100% by weight of hexanediol, with preference being given to 1,6-hexanediol and/or hexanediol derivatives. Such hexanediol derivatives are based on hexanediol and have ester or ether groups as well as terminal OH groups. Such derivatives are obtainable by reaction of hexanediol with excess caprolactone or by etherification of hexanediol with itself to form di- or trihexylene glycol.

In lieu of or in addition to pure polycarbonate diols, polyether-polycarbonate diols are also suitable as component A2) a polymeric polyol.

Hydroxyl-containing polycarbonates preferably have a linear construction.

Component A2) may likewise comprise one or more polyether polyols. Suitable polyether polyols include, for example, the well-known polyurethane chemistry polytetramethylene glycol polyethers which are obtainable by polymerization of tetra-hydrofuran by means of cationic ring opening.

Other suitable polyether polyols also include the well-known addition products of styrene oxide, ethylene oxide, propylene oxide, butylene oxides and/or epichlorohydrin onto di- and/or polyfunctional starter molecules.

Suitable starter molecules for preparation of polyether polyols include all prior art compounds such as, for example, water, butyl diglycol, glycerol, diethylene glycol, trimethylolpropane, propylene glycol, sorbitol, ethylenediamine, triethanolamine, 1,4-butanediol. Preferred starter molecules are water, ethylene glycol, propylene glycol, 1,4-butanediol, diethylene glycol and butyl diglycol.

In a particularly preferred embodiment of the invention, component (I) the aqueous, anionically hydrophilicized polyurethane dispersions, contain as component A2) a mixture of one or more polycarbonate polyols and one or more polytetramethylene glycol polyols, with the proportion of polycarbonate polyols in this mixture being in the range from 20% to 80% by weight and the proportion of polytetramethylene glycol polyols in this mixture being in the range from 80% to 20% by weight, with the sum of the %'s by weight for the polycarbonate polyols and polytetramethylene glycol polyols totaling 100% by weight. Preference is given to a proportion of 30% to 75% by weight for polytetramethylene glycol polyols and to a proportion of 25% to 70% by weight for polycarbonate polyols. Particular preference is given to a proportion of 35% to 70% by weight for polytetramethylene glycol polyols and to a proportion of 30% to 65% by weight for polycarbonate polyols, with each requiring that the sum total of the weight percentages for the polycarbonate polyols and polytetramethylene glycol polyols is 100%. In addition, the proportion of component A2) which is contributed by the sum total of the polycarbonate and polytetramethylene glycol polyether polyols is at least 50% by weight, preferably 60% by weight and more preferably at least 70% by weight, based on 100% by weight of component A2).

Suitable compounds to be used as component A3) include polyols of the specified molecular weight range which contain up to 20 carbon atoms. Specific examples include compounds such as ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrogenated bisphenol A, (2,2-bis(4-hydroxycyclohexyl)propane), trimethylolpropane, glycerol, pentaerythritol and also any desired mixtures thereof with one another.

Also suitable are ester diols of the specified molecular weight range such as, for example, α-hydroxybutyl-ε-hydroxycaproic acid ester, ω-hydroxyhexyl-γ-hydroxybutyric acid ester, β-hydroxyethyl adipate or bis(β-hydroxyethyl) terephthalate.

Component A3) may additionally comprise one or more monofunctional hydroxyl-containing compounds. Examples of such monofunctional compounds are ethanol, n-butanol, ethylene glycol monobutyl ether, diethylene glycol monomethyl ether, ethylene glycol monobutyl ether, diethylene glycol monobutyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 2-ethylhexanol, 1-octanol, 1-dodecanol, 1-hexadecanol.

Preferred compounds to be used as component A3) are 1,6-hexanediol, 1,4-butanediol, neopentyl glycol and trimethylolpropane.

Component A4) herein which is optional, comprises one or more anionically or potentially anionically hydrophilicizing compound. Thus, suitable compounds to be used as component A4) include any compound which has at least one isocyanate-reactive group such as a hydroxyl group, and also at least one other type of functionality, i.e. a functionality that is not an isocyanate-reactive group. Such functionalities include, for example, —COO⁻M⁺, —SO₃⁻M⁺, —PO(O⁻M⁺)₂ in which M⁺ represents, for example, a metal cation, H⁺, NH₄⁺, or NHR₃⁺; each R independently represents a C₁-C₁₂-alkl group, C₅-C₆-cycloalkyl group and/or C₂-C₄-hydroxyalkyl group. This functionality enters a pH-dependent dissociative equilibrium on interaction with aqueous media, and thereby can have a negative or neutral charge. Some useful anionically or potentially anionically hydrophilicizing compounds include mono- and dihydroxy carboxylic acids, mono- and dihydroxy sulfonic acids, and also mono- and dihydroxy phosphonic acids, and their salts. Examples of such anionic or potentially anionic hydrophilicizing agents are dimethylolpropionic acid, dimethylolbutyric acid, hydroxypivalic acid, malic acid, citric acid, glycolic acid, lactic acid and the propoxylated adduct formed from 2-butenediol and NaHSO₃ as described in, for example, U.S. Pat. No. 4,108,814 (which is believed to correspond to DE-A 2 446 440, see page 5-9, formula I-Hi), the disclosure of which is hereby incorporated by reference. Preferred anionic or potentially anionic hydrophilicizing agents for component A4) are those of the aforementioned kind that have carboxylate or carboxyl groups and/or sulfonate groups.

Particularly preferred anionic or potentially anionic hydrophilicizing agents to be used as component A4) are those that contain carboxylate or carboxyl groups as ionic or potentially ionic groups, such as dimethylolpropionic acid, dimethylolbutyric acid and hydroxypivalic acid and salts thereof.

Useful nonionically hydrophilicizing compounds which are suitable for use as component A4) include, for example, polyoxyalkylene ethers which contain at least one hydroxyl or amino group, and preferably at least one hydroxyl group.

Examples of these are the monohydroxyl-functional polyalkylene oxide polyether alcohols containing on average 5 to 70 and preferably 7 to 55 ethylene oxide units per molecule and obtainable in a conventional manner by alkoxylation of suitable starter molecules. Such a process is described in, for example, Ullmanns Encyclopädie der technischen Chemie, 4th edition, volume 19, Verlag Chemie, Weinheim pages 31-38.

Obviously, such compounds can not be used simultaneously as component A2) and A4). Thus, if component A2) comprises a polyether polyol prepared by addition of ethylene oxide onto suitable starter molecules, then component A4) is another type of hydrophilicizing agent. Similarly, if component A4) comprises a polyethylene oxide ether, then component A2) is another type of polymeric polyol. In this manner, components A2) and A4) are mutually exclusive.

These are either pure polyethylene oxide ethers or mixed polyalkylene oxide ethers, containing at least 30 mol% and preferably at least 40 mol% of ethylene oxide units, based on all alkylene oxide units present.

Particularly preferred nonionic compounds A4) are monofunctional mixed polyalkylene oxide polyethers having 40 to 100 mol % of ethylene oxide units and 0 to 60 mol % of propylene oxide units.

Suitable starter molecules for such nonionic hydrophilicizing agents include saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers such as, for example, diethylene glycol monobutyl ether, unsaturated alcohols such as allyl alcohol, 1,1-dimethylallyl alcohol or oleic alcohol, aromatic alcohols such as phenol, the isomeric cresols or methoxyphenols, araliphatic alcohols such as benzyl alcohol, an is alcohol or cinnamyl alcohol, secondary monoamines such as dimethylamine, diethylamine, dipropylamine, diisopropylamine, dibutylamine, bis(2-ethylhexyl)amine, N-methylcyclo-hexylamine, N-ethylcyclohexylamine or dicyclohexylamine and also heterocyclic secondary amines such as morpholine, pyrrolidine, piperidine or 1H pyrazole. Preferred starter molecules are saturated monoalcohols of the aforementioned kind. Particular preference is given to using diethylene glycol monobutyl ether or n-butanol as starter molecules.

The useful alkylene oxides for the alkoxylation reaction are, in particular, ethylene oxide and propylene oxide, which can be used in any desired order or else in admixture in the alkoxylation reaction.

Suitable compounds to be used as component B1) in accordance with the present invention include di- or polyamines such as 1,2-ethylenediamine, 1,2-diamino-propane, 1,3-diaminopropane, 1,4-diaminobutane, 1,6-diaminohexane, isophoronediamine, isomeric mixture of 2,2,4- and 2,4,4-trimethylhexa-methylenediamine, 2-methylpentamethylenediamine, diethylenetriamine, triaminononane, 1,3-xylylenediamine, 1,4-xylylenediamine, α,α,α′,α′-tetra-methyl-1,3- and -1,4-xylylenediamine and 4,4-diaminodicyclohexylmethane and/or dimethylethylenediamine. It is also possible but less preferable to use hydrazine and also hydrazides such as adipohydrazide.

Component B1) can also include compounds which, in addition to a primary amino group, also have one or more secondary amino groups or which also have one or more OH groups in addition to an amino group (primary or secondary). Examples thereof are primary/secondary amines, such as diethanolamine, 3-amino-1-methylaminopropane, 3-amino-1-ethylaminopropane, 3-amino-1-cyclohexylaminopropane, 3-amino-1-methyl-aminobutane, alkanolamines such as N-aminoethylethanolamine, ethanolamine, 3-aminopropanol, neopentanolamine, etc.

In addition, component B1) can comprise monofunctional isocyanate-reactive amine compounds such as, for example, methylamine, ethylamine, propylamine, butylamine, octylamine, laurylamine, stearylamine, isononyloxypropylamine, dimethylamine, diethylamine, dipropylamine, dibutylamine, N-methylamino-propylamine, diethyl(methyl)aminopropylamine, morpholine, piperidine, or suitable substituted derivatives thereof, amide-amines formed from diprimary amines and monocarboxylic acids, monoketimes of diprimary amines, primary/tertiary amines, such as N,N-dimethyl-aminopropylamine.

Preferred compounds for component B1) are 1,2-ethylenediamine, 1,4-diaminobutane and isophoronediamine.

Suitable anionically or potentially anionically hydrophilicizing compounds to be used as component B2) include any compound which has at least one isocyanate-reactive group, preferably an amino group, and also at least one functionality (i.e. a functionality that it not an isocyanate-reactive group) such as, for example, —COO⁻M⁺, —SO₃⁻M⁺, —PO(O³¹ M⁺)₂ where M⁺ is for example a metal cation, H⁺, NH₄⁺, NHR₃⁺, in which each R independently represents a C₁-C₁₂-alkyl, C₅-C₆-cycloalkyl and/or C₂-C₄-hydroxyalkyl. This functionality enters a pH dependent dissociative equilibrium upon interaction with aqueous media, and can thereby have a negative or neutral charge.

Some suitable anionically or potentially anionically hydrophilicizing compounds for the present invention are mono- and diamino carboxylic acids, mono- and diamino sulfonic acids and also mono- and diamino phosphonic acids and their salts. Examples of such anionic or potentially anionic hydrophilicizing agents are N-(2-aminoethyl)-β-alanine, 2-(2-aminoethylamino)ethanesulfonic acid, ethylenediaminepropylsulfonic acid, ethylenediaminebutylsulfonic acid, 1,2- or 1,3-propylenediamine-β-ethylsulfonic acid, glycine, alanine, taurine, lysine, 3,5-diaminobenzoic acid and the addition product of IPDA and acrylic acid. Such addition products of IPDA and acrylic acid are described in, for example, EP-A 0 916 647 (see Example 1) which is believed to correspond to CA 2,253,119, the disclosures of which are hereby incorporated by reference. It is also possible to use cyclohexylaminopropanesulfonic acid (CAPS) from WO-A 01/88006, which is believed to correspond to U.S. Pat. No. 6,767,958, the disclosure of which is hereby incorporated by reference, as anionic or potentially anionic hydrophilicizing agent.

Preferred anionic or potentially anionic hydrophilicizing agents for component B2) are those of the aforementioned kind that have carboxylate or carboxyl groups and/or sulfonate groups, such as the salts of N-(2-aminoethyl)-β-alanine, of 2-(2-aminoethylamino)ethanesulfonic acid or of the addition product of IPDA and acrylic acid (see Example 1 of EP-A 0 916 647).

Mixtures of anionic or potentially anionic hydrophilicizing agents and nonionic hydrophilicizing agents can also be used.

A preferred embodiment for producing the specific polyurethane dispersions utilizes components A1) to A4) and B1) to B2) in the following amounts, with the sum of the individual amounts always adding up to 100% by weight:

5% to 40% by weight of component A1),

55% to 90% by weight of A2),

0.5% to 20% by weight of the sum total of components A3) and B1), and

0.1% to 25% by weight of the sum total of the components A4) and B2), wherein from 0.1% to 5% by weight of anionic or potentially anionic hydrophilicizing agents frocomponents A4) and/or B2) are present, based on 100% by weight of components A1) to A4) and B1) to B2).

A particularly preferred embodiment for producing the specific polyurethane dispersions utilizes components A1) to A4) and B1) to B2) in the following amounts, with the sum of the the individual amounts always adding up to 100% by weight:

5% to 35% by weight of component A1),

60% to 90% by weight of component A2),

0.5% to 15% by weight of the sum total of components A3) and B1), and

0.1% to 15% by weight of the sum total of the components A4) and B2), wherein from 0.2% to 4% by weight of anionic or potentially anionic hydrophilicizing agents from A4) and/or B2) are present, based on 100% by weight of components A1) to A4) and B1) to B2).

A very particularly preferred embodiment for producing the specific polyurethane dispersions utilizes components A1) to A4) and B1) to B2) in the following amounts, with the sum of the individual amounts always adding up to 100% by weight:

10% to 30% by weight of component A1),

65% to 85% by weight of component A2),

0.5% to 14% by weight of the sum total of components A3) and B1), and

0.1% to 13.5% by weight of the sum total of the A4) and B2), wherein from 0.5% to 3.0% by weight of anionic or potentially anionic hydrophilicizing agents from A4) and/or B2) are present, based on 100% by weight of components A1) to A4) and B1) to B2).

The production of (I) the anionically hydrophilicized polyurethane dispersions can be carried out in one or more stages in homogeneous phase or, in the case of a multistage reaction, partly in disperse phase. After completely or partially conducted polyadditionof components A1) to A4), a dispersing, emulsifying or dissolving step is carried out. This is followed, if appropriate, by a further polyaddition or modification in the disperse or dissolved (homogeneous) phase.

Any of the known prior art process can be used. Specific examples of such process being the prepolymer mixing process, the acetone process or the melt dispersing process. The acetone process is preferred.

Production by the acetone process typically involves the constituents A2) to A4) and the polyisocyanate component A1) being wholly or partly introduced as an initial charge to produce an isocyanate-functional polyurethane prepolymer, and optionally, diluted with a water-miscible but isocyanate-inert solvent, and heated to temperatures in the range from 50 to 120° C. The spped of the isocyanate addition reaction can be increased using the catalysts known in polyurethane chemistry.

Useful solvents include the customary aliphatic, keto-functional solvents such as acetone, 2-butanone, etc., which can be added not just at the start of the production process but also later, optionally in portions. Acetone and 2-butanone are preferred.

Other solvents such as xylene, toluene, cyclohexane, butyl acetate, methoxypropyl acetate, N-methylpyrrolidone, N-ethylpyrrolidone, solvents having ether or ester units can additionally be used, or wholly or partly distilled off, or in the case of N-methylpyrrolidone, N-ethylpyrrolidone, remain completely in the dispersion. Preference is given, however, to not using any other solvents apart from the customary aliphatic, keto-functional solvents.

Subsequently, any constituents of A1) to A4) not added at the start of the reaction are added.

In the production of the polyurethane prepolymer from A1) to A4), the amount of substance ratio of isocyanate groups to with isocyanate-reactive groups is in the range from 1.05 to 3.5, preferably in the range from 1.2 to 3.0 and more preferably in the range from 1.3 to 2.5.

The reaction of components A1) to A4) to form the prepolymer is effected partially or completely, but preferably completely. Polyurethane prepolymers containing free isocyanate groups are obtained in this way, without a solvent or in solution.

The neutralizing step to effect partial or complete conversion of potentially anionic groups into anionic groups utilizes bases such as tertiary amines including, for example, trialkylamines having from 1 to 12 carbon atoms, preferably from 1 to 6 carbon atoms, and more preferably 2 to 3 carbon atoms in every alkyl radical, or alkali metal bases such as the corresponding hydroxides.

Examples of trialkyl amines include trimethylamine, triethylamine, methyldiethylamine, tripropylamine, N-methylmorpholine, methyldiisopropylamine, ethyldiisopropylamine and diisopropylethylamine. The alkyl radicals may also contain, for example, hydroxyl groups, as in the case of the dialkylmonoalkanol-, alkyldialkanol- and trialkanolamines. Useful neutralizing agents further include, if appropriate, inorganic bases, such as aqueous ammonia solution, sodium hydroxide or potassium hydroxide.

Preference is given to bases such as ammonia, triethylarnine, triethanolamine, dimethylethanolamine or diisopropylethylamine, and also sodium hydroxide and potassium hydroxide. It is particularly preferred that the base be selected from the group consisting of sodium hydroxide and potassium hydroxide.

The bases are employed in an amount which is between 50 and 125 mol %, and preferably between 70 and 100 mol %, based on the quantity of substance containing the acid groups to be neutralized. Neutralization can also be effected at the same time as the dispersing step, by including the neutralizing agent in the water of dispersion.

Subsequently, in a further process step, if this has not already been done or only to some extent, the prepolymer obtained is dissolved with the aid of aliphatic ketones such as acetone or 2-butanone.

In the chain extension step, the remaining isocyanate groups of the isocyanate-functional prepolymers A) with component B), the NH₂— and/or NH-functional components are reacted by chain extension, either partially or completely. Preferably, the chain extension/termination is carried out before dispersion of the prepolymers in water.

Chain termination is typically carried out using component B1) one or more amines having an isocyanate-reactive group such as methylamine, ethylamine, propylamine, butylamine, octylamine, laurylamine, stearylamine, isononyloxypropylamine, dimethylamine, diethylamine, dipropylaamine, dibutylamine, N-methylaminopropylamine, diethyl(methyl)aminopropylamine, morpholine, piperidine or suitable substituted derivatives thereof, amide-amines formed from diprimary amines and monocarboxylic acids, monoketimes of diprimary amines, primary/tertiary amines, such as N,N-dimethylamino-propylamine.

When partial or complete chain extension is carried out using component B2) one or more anionic or potentially anionic hydrophilicizing agents as described herein above with NH₂ or NH groups, chain extension of the prepolymers is preferably carried out before dispersion of the prepolymers in water.

The aminic components B1) and B2) can optionally be used in water- or solvent-diluted form in the process of the present invention. These components may be used either individually or in mixtures, with any order of addition being possible in principle.

When water or organic solvent is used as a diluent, the diluent content of the chain-extending component B) is preferably in the range from 70% to 95% by weight, based on 100% by weight of component B).

Dispersion of the prepolymer is preferably carried out following chain extension. For dispersion, the dissolved and chain-extended polyurethane polymer is either introduced into the dispersing water, if appropriate by substantial shearing, such as vigorous stirring for example, or conversely the dispersing water is stirred into the chain-extended polyurethane polymer solutions. It is preferable to add the water to the dissolved chain-extended polyurethane polymer.

Any solvent that is still present in the dispersions after the dispersing step is then typically removed by distillation. Removal during the dispersing step is likewise possible.

The residual level of organic solvents in (I) the polyurethane dispersions is typically less than 1.0% by weight, and preferably less than 0.5% by weight, based on 100% by weight of the dispersion.

The pH of (I) the polyurethane dispersions which are essential to the present invention is typically less than 9.0, preferably less than 8.5, more preferably less than 8.0 and most preferably is in the range from 6.0 to 7.5.

The solids content of (I) the polyurethane dispersions is in the range from 40% to 70%, preferably in the range from 50% to 65% and more preferably in the range from 55% to 65% by weight (based on 100% by weight of the dispersions).

The alkylpolyglycosides present in the foam additives (II) are obtainable in a conventional manner by, for example, reaction of comparatively long-chain monoalcohols with mono-, di- or polysaccharides (see Kirk-Othmer Encyclopedia of Chemical Technology, John Wiley & Sons, Vol. 24, page 29). The comparatively long-chain monoalcohols, which may also be branched, if appropriate, have preferably 4 to 22 carbon atoms, preferably 8 to 18 carbon atoms and more preferably 10 to 12 carbon atoms in an alkyl radical. Specific examples of comparatively long-chain monoalcohols are 1-butanol, 1-propanol, 1-hexanol, 1-octanol, 2-ethylhexanol, 1-decanol, 1-undecanol, 1-dodecanol (i.e. lauryl alcohol), 1-tetradecanol (i.e. myristyl alcohol) and 1-octadecanol (i.e. stearyl alcohol). It will be appreciated that mixtures of the comparatively long-chain monoalcohols mentioned can also be used.

These alkylpolyglycosides preferably have structures derived from glucose.

Particular preference is given to using alkylpolyglycosides which correspond to formula (I)

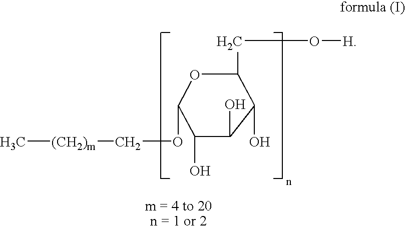

wherein:

m represents an integer of from 4 to 20, preferably of from 6 to 20, and more preferably of from 10 to 16; and

n represent 1 or 2.

The alkylpolyglycosides preferably have an HLB value of less than 20, more preferably of less than 16 and most preferably of less than 14. As used herein, the HLB value is calculated using formula HLB=20×Mh/M, where Mh represents the molar mass of the hydrophilic moiety of a molecule, and M represents the molar mass of the entire molecule (see Griffin, W. C.: Classification of surface active agents by H L B, J. Soc. Cosmet. Chem. 1, 1949).

As well as the alkylpolyglycosides, component (II) may contain further additives to improve foam formation, foam stability or the properties of the resulting polyurethane foam.

Examples of such additional additives may in principle include any anionic, nonionic or cationic surfactant known per se. However, it is preferred that esters of sulfosuccinic acid, in which the lipophilic alkyl moiety of the ester group preferably contains 8 to 24 carbon atoms, and/or alkali metal or alkaline earth metal alkanoates in which the lipophilic alkyl moiety preferably contains 12 to 24 carbon atoms, in combination with the alkyl polyglycosides. It is particularly preferred for further additives to be used to include not only esters of sulfosuccinic acid but also alkali metal or alkaline earth metal alkanoates of the aforementioned kind.

Furthermore, even ammoniumalkanrates can be used as additional additives, since the hydrophilising effect of the alkylpolyglycosides is maintained. The additional additives are preferably used in lower amounts than the alkylpolyglycerides.

As well as the polyurethane dispersions (I) and the foam additives (II), auxiliary and additive materials (III) can also be used.

Examples of such auxiliary and additive materials (III) include crosslinkers, thickeners or thixotroping agents, other aqueous binders antioxidants, light stabilizers, emulsifiers, plasticizers, pigments, fillers and/or flow control agents.

Useful crosslinkers include, for example, unblocked polyisocyanates, amide- and amine-formaldehyde resins, phenolic resins, aldehydic and ketonic resins, examples being phenol-formaldehyde resins, resols, furan resins, urea resins, carbamic ester resins, triazine resins, melamine resins, benzoguanamine resins, cyanamide resins or aniline resins.

Commercially available thickeners can be used. Suitable thickeners include derivatives of dextrin, of starch or of cellulose, examples being cellulose ethers or hydroxyethylcellulose, organic wholly synthetic thickeners based on polyacrylic acids, polyvinylpyrrolidones, poly(meth)acrylic compounds or polyurethanes (associative thickeners) and also inorganic thickeners, such as bentonites or silicas.

Other aqueous binders can be constructed, for example, of polyester, polyacrylate, polyepoxy or other polyurethane polymers. Similarly, the combination with radiation-curable binders such as those described in, for example, U.S. Pat. No. 5,684,081 (which is believed to correspond to EP-A-0 753 531), the disclosure of which is herein incorporated by reference, is also possible. It is also possible to employ other anionic or nonionic dispersions, such as polyvinyl acetate, polyethylene, polystyrene, polybutadiene, polyvinyl chloride, polyacrylate and copolymer dispersions.

The compositions which are essential to the present invention typically contain, based on dry substance, (I) from 80 to 99.9 parts by weight of the polyurethane (derived from the polyurethane dispersion), and (II) from 0.1 to 20 parts by weight of the foam additive (II). Preferably, the compositions contain, based on dry substance, (I) from 85 to 99.5 parts by weight of the polyurethane, and (II) from 0.5 to 15 parts by weight of the foam additive. More preferably, the compositions of the invention contain (I) from 90 to 99 parts by weight of polyurethane and (II) from 1 to 10 parts by weight of foam additive. In particular, the compositions contain 97,5 to 99 parts by weight of the polyurethane and 1 to 2,5 parts by weight of the foam additive.

The further additives which added as (III) auxiliary and additive materials are typically used in amounts of 0 to 10 parts by weight, preferably 0.1 to 5 parts by weight, and more preferably 0.1 to 1.5 parts by weight, based on 100% by weight of the composition of the present invention.

The addition of (II) the foam additives and of (III) the optional further additives to (I) the polyurethane dispersion can take place in any desired order. The aforementioned additives may, if appropriate, be used as a solution or dispersion in a solvent such as water.

In principle, it is also possible to bring about a coagulation of the foam by adding coagulants as part of the auxiliary and additive materials. Useful coagulants include in principle all multiply cationically functional compounds.

Frothing in the process of the present invention can be accomplished by shaking or mechanical stirring of the composition or by decompressing blowing gas.

Mechanical frothing can be effected using any desired mechanical stirring, mixing and/or dispersing techniques by introducing the energy necessary for frothing. Air is generally introduced, but nitrogen and other gases can also be used for this purpose.

The foam thus obtained is, in the course of frothing or thereafter, applied to a substrate or introduced into a mold and dried.

Application of the polyurethane foam to a substrate can be, for example, by pouring or blade coating, but other conventional techniques are also possible. Multilayered application with intervening drying steps is also possible in principle.

A satisfactory drying rate for the foams is observed at a temperature as low as 20° C. However, temperatures above 30° C. are preferably used for more rapid drying and fixing of the foams. Drying temperatures should not, however, exceed 200° C., preferably 150° C. and more preferably 130° C., since undesirable yellowing of the foams can otherwise occur, inter alia. Drying in two or more stages is also possible.

Drying is generally effected using conventional heating and drying apparatus, such as (circulating air) drying cabinets, hot air or IR radiators. Drying by leading (or passing) the coated substrate over heated surfaces such as, for example, rolls, is also possible.

Application and drying of the polyurethane foams can each be carried out batchwise or continuously, but an entirely continuous process is preferred.

Useful substrates on which the polyurethane foams can be applied include, for example, papers or films which facilitate simple detachment of the wound contact material before it is used to cover an injured site.

Before drying, the foam densities of the polyurethane foams are typically in the range from 50 to 800 g/liter, preferably in the range from 100 to 500 g/liter and more preferably in the range from 100 to 250 g/liter (mass of all input materials [in g] based on the foam volume of one liter).

After drying, the polyurethane foams have a microporous, at least partial open-cell structure comprising intercommunicating cells. The density of the dried foams is typically below 0.4 g/cm³, preferably below 0.35 g/cm³ and most preferably in the range from 0.1 to 0.3 g/cm³.

In accordance with the present invention, use of the specific additives (II), i.e. the one or more alkyl polyglycosides, provides for very rapid uptake of liquid, and in particular, of physiological saline. In general, 1 ml of test solution A, prepared according to DIN EN 13726-1 Part 3.2, is completely taken up in less than 25 seconds, preferably in less than 10 seconds and most preferably in less than 3 seconds.

The DIN EN 13726-1 Part 3.2 physiological saline absorbency is typically 100 and 1500% and preferably in the range from 300 to 800% for the polyurethane foams of the invention (i.e. the mass of liquid taken up, based on mass of dry foam). The DIN EN 13726-2 Part 3.2 water vapor transmission rate is typically in the range from 2000 to 8000 g/24 h * m² and preferably in the range from 3000 to 8000 g/24 h * m².

The polyurethane foams exhibit good mechanical strength and high elasticity. Typically, maximum stress is greater than 0.2 N/mm² and maximum extension is greater than 250%. Preferably, maximum stress is greater than 0.4 N/mm² and the extension is greater than 350% (determined according to DIN 53504).

After drying, the thickness of the polyurethane foams is typically in the range from 0.1 mm to 50 mm, preferably in the range from 0.5 mm to 20 mm, more preferably in the range from 1 to 10 mm and most preferably in the range from 1 to 5 mm.

The polyurethane foams can moreover be adhered, laminated, or coated to or with further materials such as, for example, materials based on hydrogels, (semi-) permeable films, coatings, hydrocolloids or other foams.

The polyurethane foams can moreover have added to them active compounds that have an effect on wound healing, for example.

Owing to their advantageous properties, the polyurethane foams of the present invention are preferably used as wound contact materials or for cosmetic purposes. Wound contact materials which comprise polyurethane foams within the meaning of the present invention are porous materials, preferably having at least some open-cell content, and which consist essentially of polyurethanes. These wound contact materials protect wounds against germs and environmental influences in the sense of providing a sterile covering, exhibit a rapid and high absorbence of physiological saline or wound fluid, ensure a suitable wound climate through suitable moisture permeability, and possess sufficient mechanical strength.

The present invention accordingly further provides the polyurethane foams which are produced by the process of the present invention, and also for wound contact materials comprising these polyurethane foams, and also in the cosmetic sector.

The following examples further illustrate details for the process of this invention. The invention, which is set forth in the forgoing disclosure, is not to be limited either in spirit or in scope by these examples. Those skilled in the art will readily understand that known variations of the conditions of the following procedures can be used. Unless otherwise noted, all temperatures are degrees Celcius and all percentages are percentages by weight.

### EXAMPLES

Solids contents were determined in accordance with DIN-EN ISO 3251.

NCO contents were determined, unless expressly stated otherwise, volumetrically in accordance with DIN-EN ISO 11909.

### The Following Substances and Abbreviations Were Used in the Examples:

Diaminosulfonate: NH₂—CH₂CH₂—NH—CH₂CH₂—SO₃Na (45% in water)

Polyol 1: Polycarbonate polyol having an OH number of 56 mg KOH/g, and a number average molecular weight of 2000 g/mol (commercially available as Desmophen® C2200 from Bayer MaterialScience AG, Leverkusen, Germany)

Polyol 2: Polytetramethylene glycol polyol having an OH number of 56 mg KOH/g, and a number average molecular weight of 2000 g/mol (commercially available as PolyTHF® 2000 from BASF AG, Ludwigshafen, Germany)

Polyol 3: Polytetramethylene glycol polyol having an OH number of 112 mg KOH/g, and a number average molecular weight of 1000 g/mol (commercially available as PolyTHF® 1000 from BASF AG, Ludwigshafen, Germany)

Polyol 4: Monofunctional polyether based on ethylene oxide/propylene oxide having a number average molecular weight of 2250 g/mol, and an OH number of 25 mg KOH/g (commercially available as LB 25 polyether from Bayer MaterialScience AG, Leverkusen, Germany)

Dispersion 1: An aliphatic polycarbonate-polyether-polyurethane dispersion having a solids content of 60%, and a pH of 8.0 (commercially available as Impranil® DLU from Bayer MaterialScience AG, Leverkusen, Germany)

The mean of the average particle sizes (the number average of which is reported) of the polyurethane dispersions (I) were determined using laser correlation spectroscopy. (Specifically, the instrument used was a Malvern Zetasizer 1000, Malver Inst. Limited).

Free swell absorptive capacity was determined by absorption of physiological saline in accordance with DIN EN 13726-1 Part 3.2.

The moisture vapor transition rate (MVTR) was determined in accordance with DIN EN 13726-2 Part 3.2.

The amounts reported for the foam additives are based on aqueous solutions.

### Example 1

### Preparation of Polyurethane Dispersion 1

1077.2 g of Polyol 2, 409.7 g of Polyol 3, 830.9 g of Polyol 1 and 48.3 g of Polyol 4 were heated to 70° C. in a standard stirred apparatus. Then, a mixture of 258.7 g of hexamethylene diisocyanate and 341.9 g of isophorone diisocyanate was added at 70° C. in the course of 5 minutes, and the resulting mixture was stirred at 120° C. until the theoretical NCO value was reached or the actual NCO value had dropped slightly below the theoretical NCO value. The final prepolymer was dissolved with 4840 g of acetone and, during the process, cooled down to 50° C., and subsequently admixed with a solution of 27.4 g of ethylenediamine, 127.1 g of isophoronediamine, 67.3 g of diaminosulfonate and 1200 g of water metered in over 10 min. The mixture was subsequently stirred for 10 min. Then, a dispersion was formed by addition of 654 g of water. This was followed by removal of the solvent by distillation under reduced pressure.

The resulting polyurethane dispersion had the following properties:

| | |
|---|---|
| Solids content: | 61.6% |
| Particle size (LCS): | 528 nm |
| pH (23° C.): | 7.5 |

### Comparative Examples V1-V10

### Production of Foams from Polyurethane Dispersion 1 and Impranil® DLU

As indicated in Table 1, polyurethane dispersion 1, prepared as described above in Example 1, or Impranil® DLU were mixed with various foam additives as set forth in the amounts indicated in Table 1, and frothed by means of a commercially available hand stirrer (stirrer made of bent wire) to a 0.5 or 1 liter foam volume. Thereafter, the foams were drawn down on non-stick paper by means of a blade coater set to a gap height of 6 mm and dried under the stated conditions.

Only with the additive combinations containing ammonium stearate, as in Comparative Examples V1, V2, V3 and V10, was it possible to obtain foams which were suitable for further testing. As Table 2 reveals, however, these foams exhibited an excessive hydrophobicization and hence a very low imbibition rate for physiological saline (all>60 s or>20 s). The moisture vapor transmission rate (MVTR) is comparatively low. None of the other additives which were used in Comparative Examples V4 through V8 gave any foams at all (i.e. there was insufficient foam-forming power on the part of the additives).

TABLE 1

| | | (Foam) additives | | | | |
|---|---|---|---|---|---|---|
| Foam No. | | Type³⁾ | Amount [g] | Type³⁾ | Amount [g] | Curing |
| | Polyurethane | | | | | |
| | dispersion 1 | | | | | |
| V1 | 235.0¹⁾ | A | 8.5 | B | 11.3 | 60 min 60° C., |
| | | | | | | 10 min 120° C. |
| V2 | as for V1 | | | | | 30 min 60° C., |
| | | | | | | 10 min 120° C. |
| V3 | 235.0¹⁾ | A | 8.5 | C | 0.9 | 60 min 60° C., |
| V4 | 117.5²⁾ | C | 0.5 | D | 2.5 | 10 min 120° C. |
| V5 | 117.5²⁾ | C | 0.5 | E | 2.5 | |
| V6 | 117.5²⁾ | C | 0.5 | F | 2.5 | |
| V7 | 117.5²⁾ | C | 0.5 | G | 2.5 | |
| V8 | 117.5²⁾ | C | 0.5 | H | 2.5 | |
| V9 | 117.5²⁾ | C | 0.5 | I | 2.5 | |
| | Impranil ® DLU | | | | | |
| V10 | 117.5²⁾ | A | 4.2 | B | 5.6 | 10 min 120° C. |

¹⁾Foam volume 1000 ml;
²⁾foam volume 500 ml;
³⁾The following foam additives A through I were used: A: ammonium stearate (about 30%, Stokal ® STA, Bozzetto GmbH, Krefeld, DE); B: sulfosuccinamate (about 34%, Stokal ® SR, Bozzetto GmbH, Krefeld, DE); C: bis(2-ethylhexyl) sulfosuccinate, sodium salt; D: alkylaryl polyglycol ether sulfate, Na salt (Disponil ® AES 25, Cognis Deutschland GmbH & Co. KG, Düsseldorf, DE); E: modified fatty alcohol polyglycol ether (about 75%, Disponil ® AFX 2075, Cognis Deutschland GmbH & Co. KG, Düsseldorf, DE); F: fatty alcohol polyglycol ether sulfate, Na salt (Disponil ® FES 61, Cognis Deutschland GmbH & Co. KG, Düsseldorf, DE); G: fatty alcohol polyglycol ether sulfate, Na salt (Disponil ® FES 993, Cognis Deutschland GmbH & Co. KG, Düsseldorf, DE); H: C₁₃ fatty alcohol ethoxylate (about 70%, Emulan ® TO 4070, BASF AG, Ludwigshafen, DE); I: polyoxyethylene sorbitan monolaureate

TABLE 2

| | | Free swell absorptive | MVTR |
|---|---|---|---|
| Foam No. | Imbibition rate¹⁾ [s] | capacity [g/100 cm²] | [g/m² * 24 h] |
| V1 | >60²⁾ | 33.6 | 1493 |
| V2 | >60³⁾ | 26.7 | n.d. |
| V3 | >60⁴⁾ | 31.1 | n.d. |
| V10 | >20⁴⁾ | n.d. | n.d. |

¹⁾time for complete penetration of one milliliter of test solution A prepared as in DIN EN 13726-1 Part 3.2; test on side facing the paper;
²⁾initial measurement;
³⁾measurement after 4 d storage;
⁴⁾measurement after 1 d storage

### Examples S1-S5

### Production of Foams from Polyurethane Dispersion 1 and Impranil® DLU

As indicated in Table 3, polyurethane dispersion 1, prepared as described above in Example 1, or Impranil® DLU were mixed with various (foam) additives, and frothed by means of a commercially available hand stirrer (stirrer made of bent wire) to a 0.5 liter foam volume. Thereafter, the foams were drawn down on non-stick paper by means of a blade coater set to a gap height of 6 mm, and dried under the stated conditions.

Fresh white foams having good mechanical properties and a fine pore structure were obtained without exception. As shown in Table 4, when using the specific (foam) additives of this invention, it appreciably enhanced the imbibition rate with regard to physiological saline (all<1 s). In addition, all the foams exhibit good free swell absorptive capacity and also a high moisture vapor transmission rate.

TABLE 3

| | | | (Foam) additives | | | | | |
|---|---|---|---|---|---|---|---|---|
| Foam No. | | Type¹⁾ | Amount [g] | Type¹⁾ | Amount [g] | Type¹⁾ | Amount [g] | Curing |
| | Polyurethane | | | | | | | |
| | dispersion 1 | | | | | | | |
| S1 | 117.5 | C | 0.5 | J | 6.1 | — | — | 60 min |
| S2 | 127.1 | C | 0.5 | J | 6.1 | — | — | 60° C., |
| | | | | | | | | 10 min |
| | | | | | | | | 120° C. |
| S3 | 120.0 | C | 0.90 | J | 6.1 | K | 0.27 | 10 min |
| S4 | 120.0 | C | 0.23 | J | 3.1 | K | 0.14 | 120° C. |
| | Impranil ® | | | | | | | |
| | DLU | | | | | | | |
| S5 | 120.0 | C | 0.23 | J | 3.1 | K | 0.14 | 10 min |
| | | | | | | | | 120° C. |

¹⁾The following foam additives C, J and K were used: C: bis(2-ethylhexyl) sulfosuccinate, Na salt; J: alkylpolyglycoside based on dodecyl alcohol (about 52%, Simulsol ® SL 26, Seppic GmbH, Cologne, DE); K: sodium stearate

TABLE 4

| | | Free swell absorptive | MVTR |
|---|---|---|---|
| Foam No. | Imbibition rate¹⁾ [s] | capacity [g/100 cm²] | [g/m² * 24 h] |
| S1 | 1²⁾ | 32.1 | 1900 |
| | 1³⁾ | | |
| S2 | 1³⁾ | 32.0 | n.d. |
| S3 | 1 | 31.3 | n.d. |
| S4 | 1 | 42.0 | 3900 |
| S5 | 1³⁾ | 43.4 | n.d. |

¹⁾time for complete penetration of one milliliter of test solution A prepared as described in DIN EN 13726-1 Part 3.2; test on side facing the paper;
²⁾initial measurement;
³⁾measurement after 1 d storage

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

### Example S6

### Production of Hydrophilic Foams with Minor Amounts of Ammonium Stearate

120 g of the polyurethane dispersion 1 prepared as described in example 1, were mixed with 1,47 g Plantacare® 1200 UP*⁾ (with citric acid adjusted to pH 7) and 0,24 g Stokal(® STA. By stirring with a conventional hand mixer, the composition was foamed for 20 minutes to a foam volume of 500 ml. After this, the foam was applied to release paper using a doctor's blade (gap: 6 mm). Finally, the foam was dried 20 minutes at 120° C.

*⁾ Alkylpolyglycoside based on C12 to C16 alcohols, ca. 50 wt.-% in water, Cognis GmbH & Co. KG, Düisseldorf, DE

A plain white, fine porous and hydrophilic foam was obtained (absorption of 1 ml test solution A in less than 3 seconds).

1. A process for preparing polyurethane foam comprising reacting at least one polyisocyanate component with at least one isocyanate-reactive component in the presence of a stabilizer comprising one or more alkylpolyglycoside.

2. The process of claim 1, in which the foams additionally contain at least one hydrophilicizing agent.

3. The process of claim 1, in which the polyurethane foams are obtained from aqueous polyurethane dispersions by physical drying.

4. The process of claim 1, in which said alkylpolyglycosides correspond to formula (I) 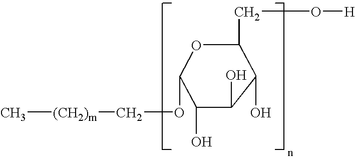
wherein:
m represents an integer of from 4 to 20;
and
n represents 1 or 2.

5. Polyurethane foam forming compositions comprising (I) at least one aqueous, anionically hydrophilicized polyurethane dispersion, and (II) one or more foam additives, in which (II) the foam additives comprise one or more alkylpolyglycosides.

6. The polyurethane foam forming compositions of claim 5, in which (I) the aqueous, anionically hydrophilicized polyurethane dispersions comprise the reaction product of
A) at least one isocyanate-functional prepolymer which comprises the reaction product of
A1) at least one organic polyisocyanate,
with
A2) at least one polymeric polyol having a number-average molecular weights in the range from 400 to 8000 g/mol and OH functionalities in the range from 1.5 to 6,
and
A3) optionally, one or more hydroxyl-functional compounds having molecular weights in the range from 62 to 399 g/mol,
and
A4) optionally, one or more isocyanate-reactive, anionic or potentially anionic and optionally nonionic hydrophilicizing agents;
with
B) one or more compounds selected from the group consisting of:
B1) optionally, one or more amino-functional compounds having molecular weights in the range from 32 to 400 g/mol,
and/or
B2) one or more isocyanate-reactive, anionic or potentially anionic hydrophilicizing agents;
in which the free NCO groups of A) are reacted completely or partially by chain extension, and in which A) the prepolymers are dispersed in water before, during or after the reaction with component B), and conversion of any potential ionic groups that are present into the ionic form by partial or complete reaction with a neutralizing agent.

7. The compositions of claim 6, in which the isocyanate-reactive groups of component B2) are preferably amino-functional groups.

8. The compositions of claim 6, wherein A1) said organic polyisocyanate is selected from the group consisting of 1,6-hexamethylene diisocyanate, isophorone diisocyanate, the isomeric bis-(4,4′-isocyanatocyclo-hexyl)methanes and mixtures thereof; and A2) said polymeric polyols comprise at least 70% by weight, based on 100% by weight of A2), of a mixture of polycarbonate polyols and polytetramethylene glycol polyols.

9. The compositions of claim 5, in which said alkylpolyglycosides correspond to formula (I) 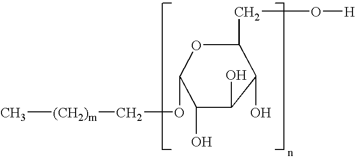
wherein:
m represents an integer of from 4 to 20:
and
n represents 1 or 2.

10. The compositions of claim 5, in which said alkylpolyglycosides are selected from the group consisting of esters of sulfosuccinic acid, esters of alkali metal alkanoates and esters of alkaline earth metal alkanoates.

11. A process for producing polyurethane foams, comprising frothing and physically drying a polyurethane foam forming composition, in which the polyurethane foam forming composition comprises (I) at least one aqueous, anionically hydrophilicized polyurethane dispersion, and (II) one or more foam additives, in which (II) the foam additives comprise one or more alkylpolyglycosides.

12. The polyurethane foam produced by the process of claim 11.

13. Polyurethane wound dressing foams produced by the process of claim 11.
